(19) United States
(12) Patent Application Publication
(10) Pub. No.: US 2008/0104636 A1
(43) Pub. Date: May 1, 2008

(54) Digital broadcast channel selection apparatus, digital broadcast receiving apparatus, and digital broadcast channel selection method

(75) Inventor: Seiichi Tanaka, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/980,634

(22) Filed: Oct. 31, 2007

(30) Foreign Application Priority Data
Oct. 31, 2006 (JP) 2006-297142

(51) Int. Cl. H04N 5/445

(52) U.S. Cl. 725/38

(57) ABSTRACT

According to one embodiment, A digital broadcast channel selection apparatus comprises first and second tuners each receive digital broadcast signals, select a channel and provide program data containing video data and audio data of the channel selected, a selection unit which selects one of the first and second tuners and provides program data acquired from the tuner selected, and a control unit which causes the selection unit to select one of the first and second tuners in accordance with a channel selection instruction and which controls the other tuner so as to select a channel adjacent to the channel selected by the one of the tuners.

### CROSS-REFERENCE TO RELATED APPLICATIONS

This application is based upon and claims the benefit of priority from Japanese Patent Application No. 2006-297142, filed Oct. 31, 2006, the entire contents of which are incorporated herein by reference.

### BACKGROUND

1. Field

One embodiment of the present invention relates to a digital broadcast receiving apparatus that receives digital broadcasts.

2. Description of the Related Art

In recent years the digital broadcasting of TV programs has advanced. TV receivers and DVD recorders that receive digital DBS or digital terrestrial broadcasts are now being used in increasing numbers. Digital TV receivers that incorporate a recording unit such as an HDD and a dual tuner comprising two tuning circuits, are being manufactured and are available in the market. A digital TV receiver that incorporates a dual tuner can display one terrestrial digital broadcast while recording another.

To select a channel for viewing a digital broadcast on a digital broadcast viewing apparatus such as a digital TV receiver, the user of the TV receiver pushes a channel selection button of the receiver. The time that elapses until the receiver finishes selecting the channel is usually much longer than at the conventional analog TV receiver. In the TV receiver incorporating a dual tuner, one tuner may receive a program, while the other tuner remains set to receive a program the user has frequently enjoyed in the past. In this case, the latter program can be selected with high probability when the user pushes the channel selection button. Thus, the overall channel selection time can be shortened (see Jpn. Pat. Appln. KOKAI Publication No. 2005-354283, FIG. 4 and claim 3).

However, the user does not always switches a program to the program he or she enjoyed frequently in the past. Further, when any other user, for example, another member of the family uses the TV receiver, the TV receiver cannot determine whose channel selection record should be referred to. Consequently, it is difficult to shorten the time for selecting digital broadcast channels.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of a TV receiver 100, i.e., an example of a digital broadcast receiver to which this invention is applied;

FIG. 2 is a block diagram schematically showing the configuration of a first embodiment of a channel selection circuit 8 that is used as a digital broadcast channel selection apparatus according to the present invention;

FIG. 3 is a diagram illustrating how each tuner selects a channel in the first embodiment;

FIG. 4 is a flowchart explaining the operation of the first embodiment;

FIG. 5 is a diagram illustrating how each tuner selects a channel in a modification of the first embodiment;

FIG. 6 is a flowchart explaining the operation of the modification of the first embodiment;

FIG. 7 is a block diagram schematically showing the configuration of a channel selection circuit 8 used as a digital broadcast channel selection apparatus in a second embodiment of this invention;

FIG. 8 is a flowchart explaining the operation of the second embodiment;

FIG. 9 shows a set of channel selection periods allocated to channels that the non-display-side tuner may select in the second embodiment;

FIG. 10 shows another example of channel selection time allocated to the non-display-side tuner;

FIG. 11 is a flowchart explaining a process of generating a histogram for each channel;

FIG. 12 is a flowchart explaining a process of generating a histogram for each genre;

FIG. 13 is a flowchart explaining a process of generating a histogram for each performer;

FIG. 14 is a timing chart illustrating the operation of a third embodiment;

FIG. 15 is a flowchart explaining the operation of the third embodiment; and

FIG. 16 is a flowchart explaining how the tuner, which has become the non-display-side tuner in accordance with the type of the channel selection button pushed, selects a channel in a fourth embodiment.

### DETAILED DESCRIPTION

Various embodiments according to the invention will be described hereinafter with reference to the accompanying drawings. In general, a digital broadcast receiving apparatus according to one embodiment of the invention comprises a digital broadcast channel selection apparatus. The digital broadcast channel selection apparatus comprises: first and second tuners which select two channels, respectively, and receive two digital broadcast signals of the channels selected, respectively, and provide program data items, respectively, each containing the video data and audio data of the channel selected; a selection unit which selects one of the first and second tuners and provides the program data item acquired from the tuner selected; and a control unit which causes the selection unit to select one of the first and second tuners in accordance with a channel selection instruction and which controls the other tuner, causing the same to select a channel adjacent to the channel selected by said one of the tuners.

In the digital broadcast receiving apparatus having a dual tuner, the time required to select a channel can be shorter than in the conventional receiving apparatus.

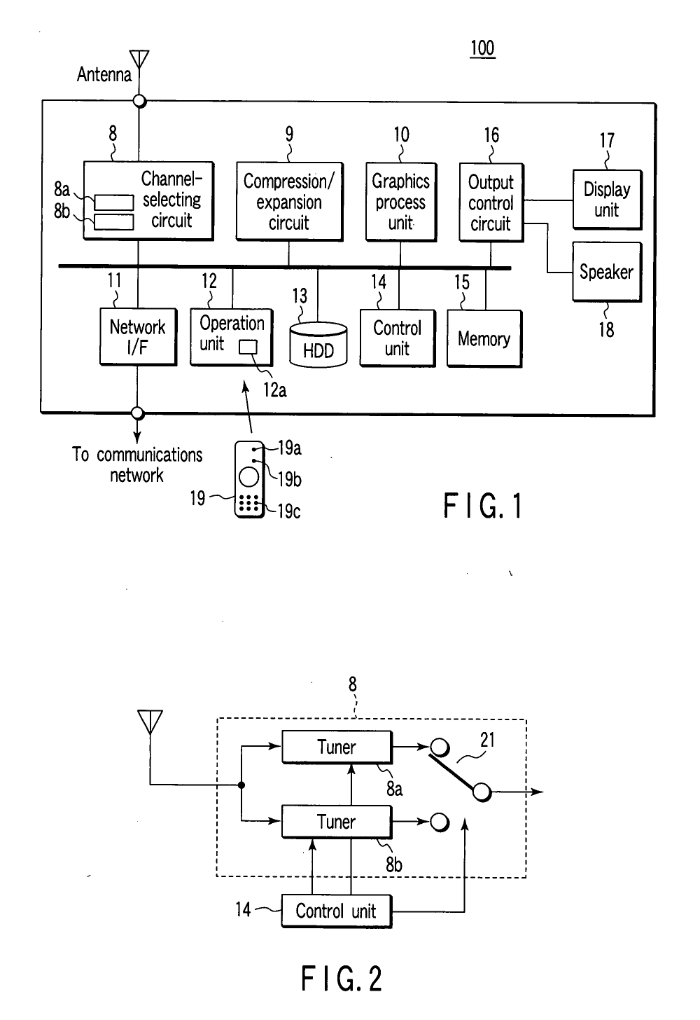

FIG. 1 is a block diagram showing the configuration of a TV receiver 100, i.e., an example of a digital TV receiver to which this invention is applied.

The TV receiver 100 comprises a channel selection circuit 8, an MPEG compression/expansion circuit 9, a graphics process unit 10, a network interface (I/F) 11, an operation unit 12, an HDD 13, a control unit 14, a memory 15, an output control circuit 16, a display unit 17, and a speaker 18.

The channel selection circuit 8 is an embodiment of a digital broadcast channel selection apparatus according to the present invention. The circuit 8 includes two tuners 8a and 8b. Each tuner receives a broadcast signal caught by the antenna of the TV receiver 100. The broadcast signal contains a video signal and an audio signal, which correspond to the content of a program, i.e., program data. The video and audio signals are multiplexed with electronic program guide (EPG) information (hereinafter referred to as program information). The program information will be used to prepare an electronic program guide that describes the genres of programs, the names of performers and the like.

The tuners 8a and 8b select channels and receive specific program data items from the input broadcast signal. One of the tuners 8a and 8b is selected on the basis of the channel selection instruction input from the operation unit 12. The tuner thus selected selects a channel. The program data of the channel selected is expanded (decoded) by the compression/expansion circuit 9. The output control circuit 16 converts the video data of the channel selected, into a video signal fit for displaying on the display unit 17. The display unit 17 displays an image represented by the video signal supplied from the output control circuit 16.

The graphics process unit 10 provides a display data that is used for on-screen display (OSD) of the electronic program guide or various setting menus on the display unit 17. The display data provided by the graphics process unit 10 is synthesized with the video data that has been expanded by the compression/expansion circuit 9. The resultant synthesized data is supplied via the output control circuit 16 to the display unit 17. The display unit 17 displays this data. The audio data expanded by the compression/expansion circuit 9 is supplied to the output control circuit 16. The circuit 16 converts the audio data to an analog audio signal, which is supplied to the speaker 18. The speaker 18 generates sound from the analog audio signal.

To record a digital broadcast in the HDD 13, the program data acquired by the channel selection circuit 8 is converted to data of such format fit for the HDD 13. To record an analog-broadcast program in the HDD 13, the analog-broadcast signal acquired by the channel selection circuit 8 is converted to digital data, compressed by the compression/expansion circuit 9 and recorded in the HDD 13.

The memory 15 includes a ROM and a RAM. The ROM stores various control programs. The RAM is used as a working area for the control unit 14. The network interface 11 functions as interface to a communications network that can transmit data at high speed, such as the Ethernet (registered trademark).

A remote controller 19 has various keys that the user may operate to input various instructions to the TV receiver 100. The operation unit 12 has a receiving unit 12a, in addition to various operation buttons. The unit 12a can receive the user's various instructions from the remote controller 19. The remote controller 19 has a channel-up key 19a, a channel-down key 19b, and a direct-channel button pad 19c. When pushed, the channel-up key 19a switches the channel number to a channel number of the next upper channel. When pushed, the channel-down key 19b switches the channel number to a channel number of the next lower channel. The direct-channel button pad 19c is composed of a plurality of direct-channel buttons, each may be pushed to select a particular channel. The channel-up key 19a, the channel-down key 19b and the direct-channel button pad 19c will be generally called channel selection buttons hereinafter.

### First Embodiment

FIG. 2 is a block diagram that schematically shows the configuration of a first embodiment of the channel selection circuit 8 used as a digital broadcast channel selection apparatus according to this invention.

As described above, the tuners 8a and 8b receive and demodulate the digital broadcast TV signal the antenna has caught. The channel selection circuit 8 has a selection unit 21, which selects the video and audio signals contained in the TV signal demodulated by the tuner 8a or 8b. The video signal selected is output to the display unit 17, and the audio signal selected is output to the speaker 18. On receiving the user's instructions, the control unit 14 controls the channel selections of the tuner 8a and tuner 8b and the selecting operation of the selection unit 21 to select either the tuner 8a or tuner 8b.

In the following description, one of the tuners, i.e., tuner 8a or 8b, which has selected the channel whose program is being displayed at the display unit 7, will be called display-side tuner. The other tuner that has selected any channel other than the channel whose program is being displayed at the display unit 7 will be called non-display-side tuner.

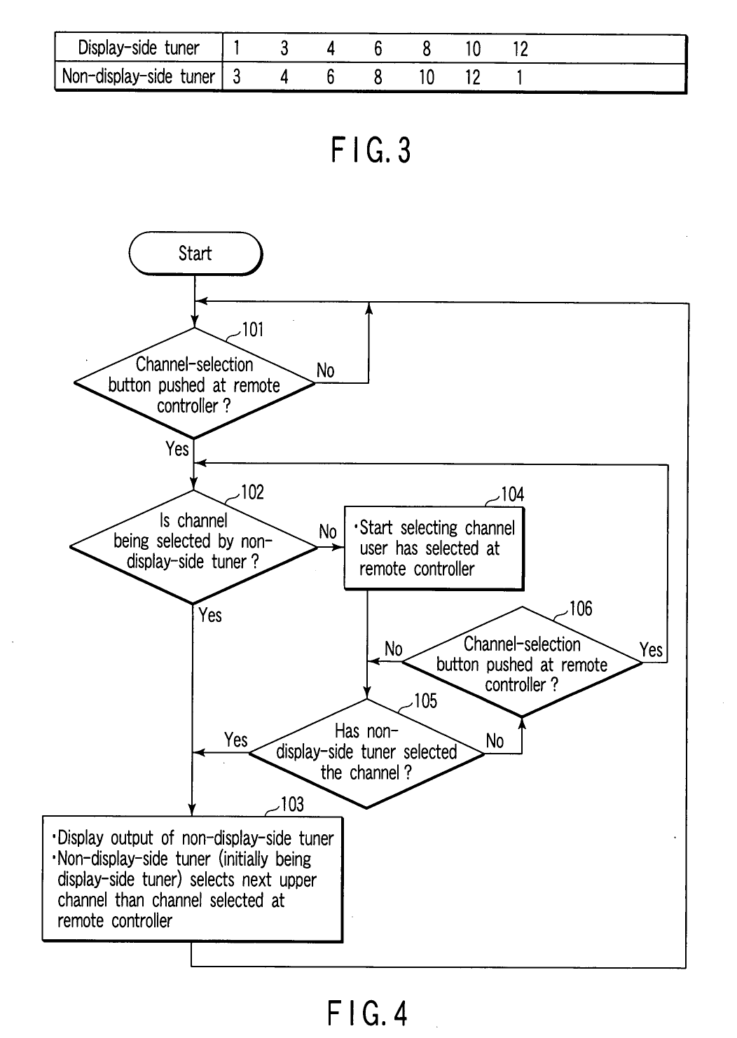

FIG. 3 is a diagram illustrating how each tuner selects a channel in the first embodiment. More precisely, the channels, each selected by the display-side tuner, are shown in association with the numbers of channels, respectively, each selected by the non-display-side tuner. As seen from FIG. 3, the non-display-side tuner always selects a channel that is an up-side one with respect to the channel selected by the display-side tuner. For example, the non-display-side tuner selects Ch3 (i.e., the channel next to Ch1) when the display-side tuner selects Ch1. As another example, the non-display-side tuner selects Ch4 when the display-side tuner selects Ch3.

FIG. 4 is a flowchart explaining the operation of the first embodiment. The first embodiment operates under the control of the control unit 14.

When one of the channel selection buttons of the remote controller 19 is pushed, selecting a channel, it is determined whether this channel is being selected by the tuner that is the non-display-side tuner at present (Blocks 101 and 102). If the channel has been selected by the non-display-side tuner (if Yes in Block 102), the output of the non-display-side tuner is displayed (Block 103). That is, the selection unit 21 changes the non-display-side tuner to a display-side tuner. The tuner that has just become the non-display-side tuner selects the next upper channel than the channel the remote controller 19 has selected.

If the channel is not found in Block 102 to be the channel being selected by the non-display-side tuner (if No in Block 102), the non-display-side tuner starts selecting the channel the user has selected by pushing a channel selection button provided on the remote controller 19 (Block 104). When the non-display-side tuner finishes selecting the channel (if Yes in Block 106), the output of the non-display-side is displayed. In other words, the non-display-side tuner becomes the display-side tuner. The tuner that has just become the display-side tuner selects the next upper channel than the channel selected by the remote controller 19 (Block 103). While the non-display-side tuner is selecting a channel, any channel selection button of the remote controller 19 may be pushed (Yes in Block 105). In this case, the flow returns to Block 102.

[Modification]

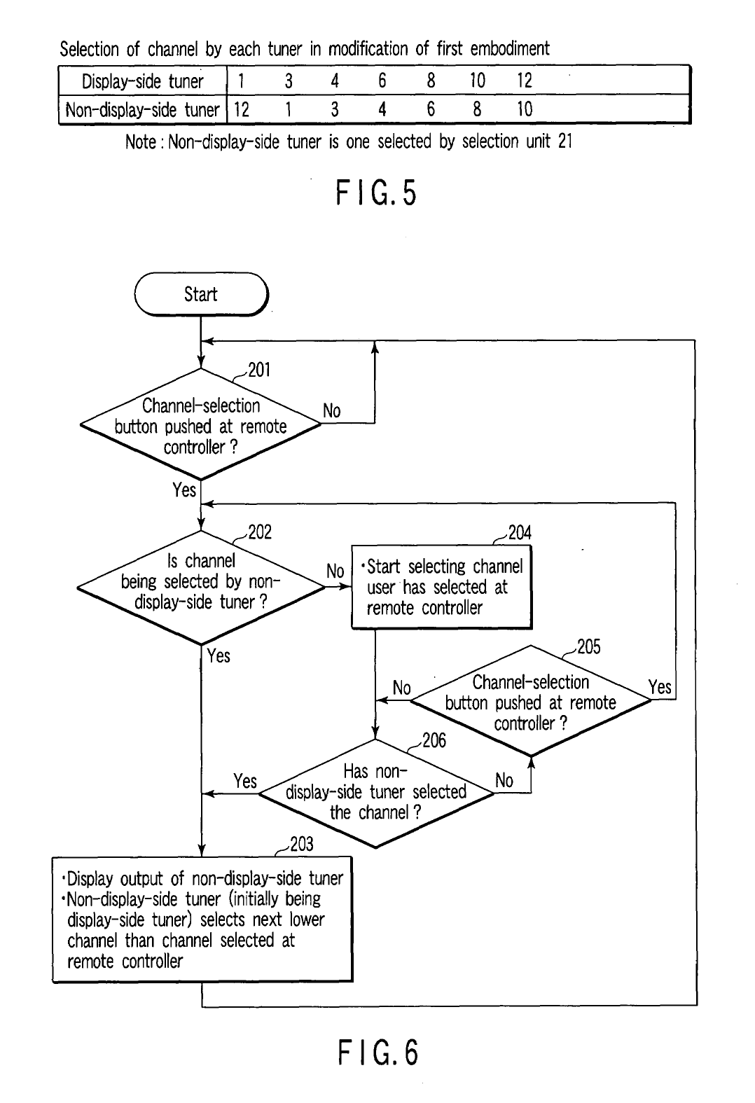

A modification of the first embodiment will be described. FIG. 5 is a diagram illustrating how each tuner selects a channel in the modification.

As seen form FIG. 5, the non-display-side tuner always selects a channel that is a down-side one with respect to the channel selected by the display-side tuner in the modification of the first embodiment. For example, the non-display-side tuner selects Ch12 when the display-side tuner selects Ch1. As another example, the non-display-side tuner selects Ch1 when the display-side tuner selects Ch3.

FIG. 6 is a flowchart explaining the operation of the modification. The operation is performed under the control of the control unit 14.

When one of the channel selection buttons of the remote controller 19 is pushed (if Yes in Block 201), selecting a channel, it is determined whether this channel is being selected by the non-display-side tuner at present (Blocks 202). If the channel has been selected by the non-display-side tuner (if Yes in Block 202), the output of the non-display-side tuner is displayed (Block 203). That is, the non-display-side tuner becomes the display-side tuner. The tuner that has just become the non-display-side tuner selects the next lower channel than the channel the remote controller 19 has selected.

If the channel is not found in Block 202 to be the channel being selected by the non-display-side tuner (if No in Block 202), the non-display-side tuner starts selecting the channel the user has selected by pushing a button provided on the remote controller 19 (Block 204). When the non-display-side tuner completes the channel selection operation, the output of the non-display-side is displayed (Block 203). In other words, the non-display-side tuner becomes the display-side tuner. The tuner that has just become the non-display-side tuner selects the next lower channel than the channel selected by the remote controller 19 (Block 203). While the non-display-side tuner selecting a channel, any channel selection button of the remote controller 19 may be pushed (Yes in Block 204). In this case, the flow returns to Block 202.

In the process of switching the displayed channel as shown in FIG. 3 or 5, a message, e.g., “Channel being selected,” may be displayed until the program of the selected channel is received and the channel can therefore be switched.

The TV receiver 100 may be so designed that the user can set the non-display-side tuner. More specifically, the user can set the non-display side tuner so that this tuner selects either a channel that is an upper channel as shown in FIG. 3, or a channel that is a lower channel as shown in FIG. 5.

[Advantage]

As described above, the tuner selects the channel (up-side channel) following the channel displayed at present in the first embodiment, whereas the tuner selects the channel (down-side channel) preceding the channel displayed at present in the modification.

Operating the remote controller 19 to switch from one channel to another and check what is on the different channels is called channel surfing or zapping. In most channel surfing, either the channel-up key 19a or the channel-down key 19b is used, changing the channel to the up-side channel or down-side channel every time the key 19a or 19b is pushed.

In the present embodiment, the non-display-side tuner selects either the up-side channel or the down-side channel with respect to the channel the display-side tuner has selected, and a program is received through the channel thus selected. This can shorten the time that elapses until the normal image and sound are output if the channel is continuously switched from one to another as in channel surfing.

The display unit 7 displays the message “Channel being selected” when the non-display-side tuner selects a channel and keeps displaying this message until the channel is switched to the selected channel. Hence, the user can know that the TV receiver 100 has responded to his or her remote-controlling. Thus, the user need not be anxious until the channel is switched to the selected channel.

### Second Embodiment

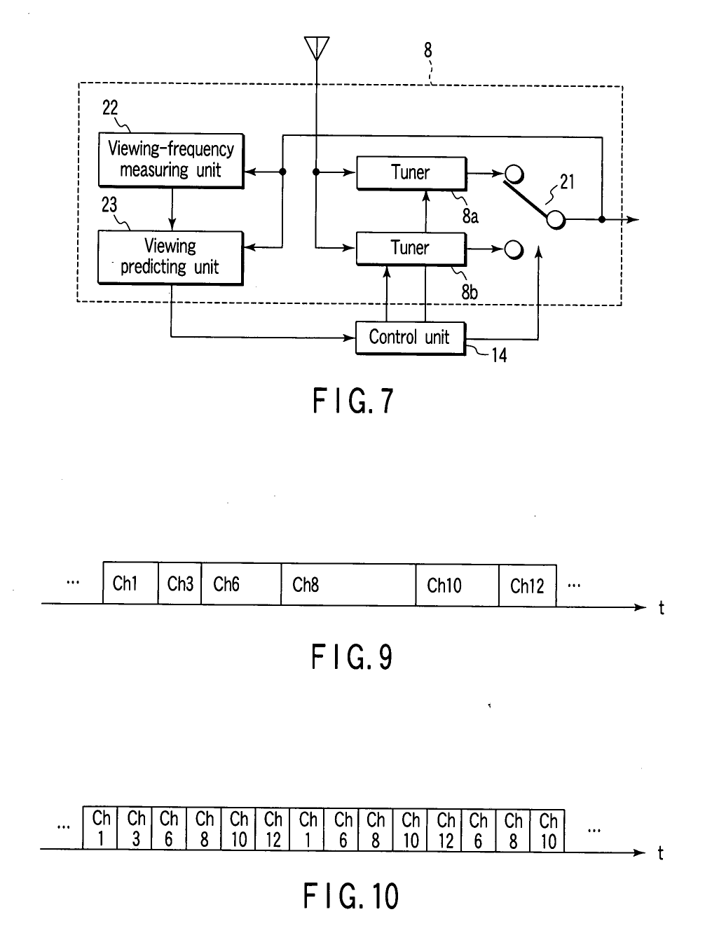

FIG. 7 is a block diagram schematically showing the configuration of a channel selection circuit 8 that is used as a digital broadcast channel selection apparatus in a second embodiment of this embodiment.

This channel selection circuit 8 has a viewing-frequency measuring unit 22 and a viewing predicting unit 23. The viewing-frequency measuring unit 22 extracts the channel-number information from the broadcast signal of any program the user has selected, stores this information in association with the time bracket in which the program is broadcast, and generates a channel viewing-frequency histogram in which the channels selected are collated with the time brackets. The viewing-frequency histogram is sent to the viewing predicting unit 23. The viewing predicting unit 23 calculates a ratio of the viewing frequencies of channels not displayed at present, from the viewing-frequency histogram and the channel number the selection unit 21 has selected. The viewing frequency ratio thus calculated is sent to the control unit 14.

The control unit 14 controls the channel selection operation of the non-display-side tuner in accordance with the viewing frequency ratio sent from the viewing predicting unit 23. More specifically, the non-display-side tuner cyclically selects each channel having a viewing frequency, during a channel selection period that accords with the viewing frequency ratio.

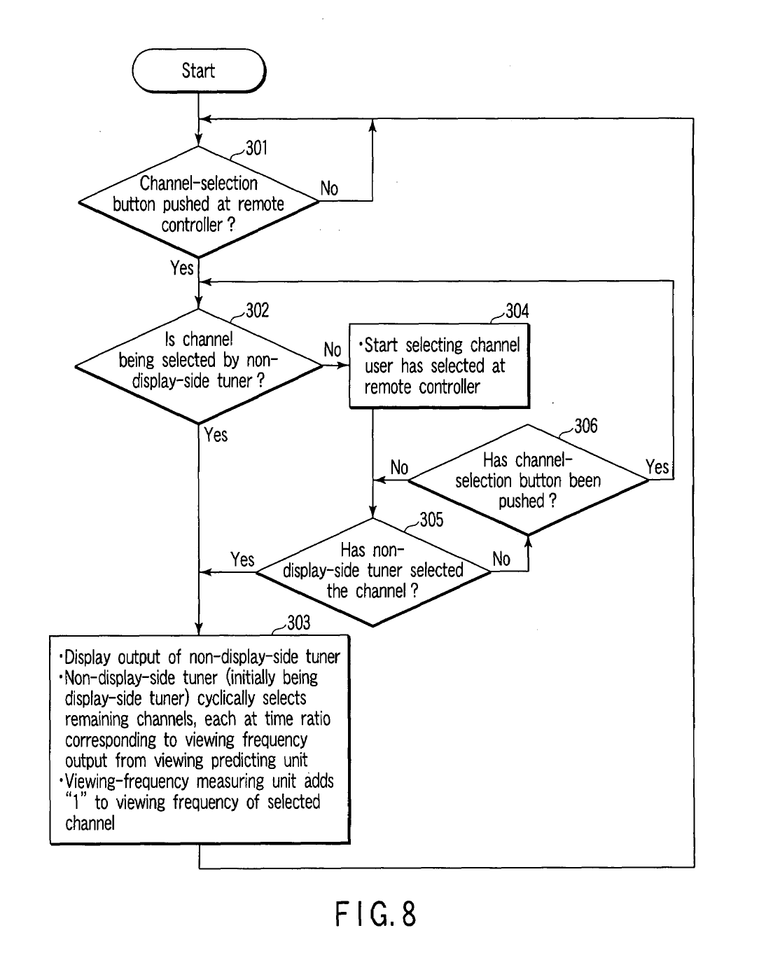

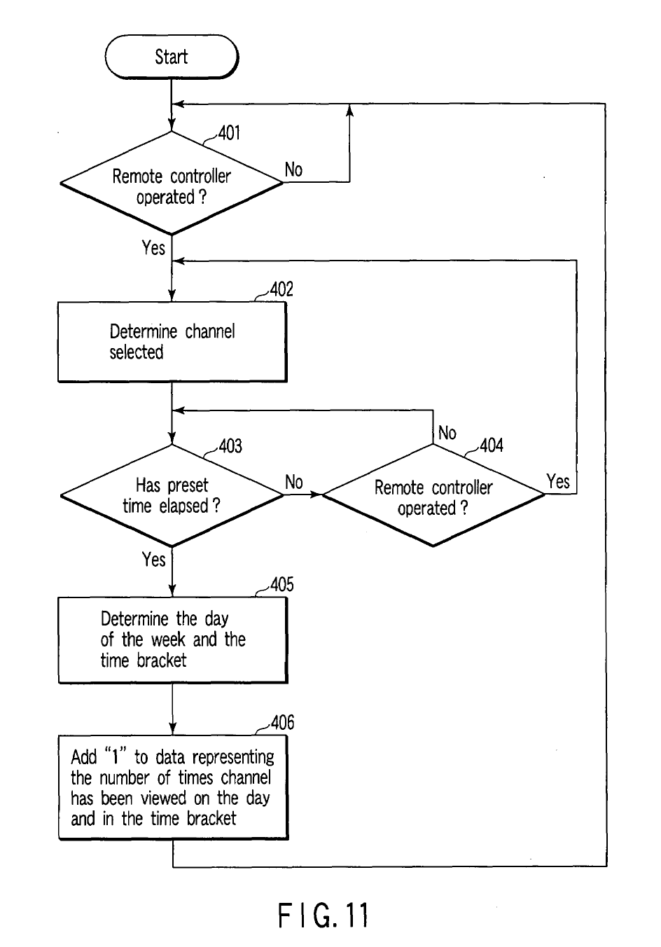

FIG. 8 is a flowchart explaining the operation of the second embodiment. This operation is performed under the control of the control unit 14.

When one of the channel selection buttons of the remote controller 19 is pushed (if Yes in Block 301), it is determined whether this channel is being selected by the tuner that is the non-display-side tuner at present (Blocks 302). If the channel has been selected by the non-display-side tuner (if Yes in Block 302), the output of the non-display-side tuner is displayed (Block 303). That is, the non-display-side tuner becomes the display-side tuner. The tuner that has just become the non-display-side tuner cyclically selects the remaining channels, each at a time ratio corresponding to the viewing frequency ratio output from the viewing predicting unit 23. The viewing-frequency measuring unit 22 adds “1,” i.e., a numerical value corresponding to one program-viewing, to the viewing-frequency data for the channel the user has selected.

If the channel is not found in Block 302 to be the channel being selected by the non-display-side tuner (if No in Block 302), the non-display-side tuner starts selecting the channel the user has selected by pushing a button provided on the remote controller 19 (Block 304). When the channel selection operation of the non-display-side tuner is completed (Yes in Block 305), the output of the non-display-side is displayed (Block 303). In other words, the non-display-side tuner becomes the display-side tuner. The tuner that has just become the non-display-side tuner cyclically selects the remaining channels each having a viewing frequency, during periods that accord with the viewing frequency ratio output from the viewing predicting unit 23. The viewing-frequency measuring unit 22 adds “1” to the viewing-frequency data for the channel the user has selected. Any one of the channel selection buttons of the remote controller 19 may be pushed while the non-display-side tuner is selecting a channel (Yes in Block 306). In this case, the flow returns to Block 302.

It will be explained the channel selection operation of non-display-side tuner. FIG. 9 shows an example of channel selection time allocated to the non-display-side tuner in the second embodiment.

Assume that the selection unit 21 has selected the tuner 8a, therefore the tuner 8a is the display-side tuner and the tuner 8a is receiving Ch4, for example. The tuner 8b then cyclically receives Ch1, Ch3, Ch6, Ch8, Ch10 and Ch12 as shown in FIG. 9. In this instance, Ch8 has a high viewing frequency, whereas Ch3 has a low viewing frequency.

The user may selects Ch8 while the tuner 8b is cyclically receiving channels not displayed. In this case, the control unit 14 connects the selection unit 21 to the tuner 8b if the tuner 8b is receiving Ch8. Further, the control unit 14 controls the tuner 8a, making the tuner 8a cyclically select the non-display-side channels during the periods that accord with the viewing frequency ratio of channels other than Ch8.

When the tuner 8b is receiving a channel other than Ch8, the control unit 14 controls the tuner 8b to receive Ch8. When the tuner 8b gets to receive Ch8 reliably, the control unit 14 connects the selection unit 21 to the tuner 8b. Further, the control unit 14 controls the tuner 8a, making the tuner 8a cyclically select the non-display-side channels during the periods that accord with the viewing frequency ratio of channels other than Ch8.

[Modification]

FIG. 10 shows another example of channel selection time allocated to the non-display-side tuner.

In the scheme shown in FIG. 9, the channel selection time is set in accordance with the viewing frequency of each channel. In the scheme shown in FIG. 10, the same channel selection time is set for all channels, and a selection frequency is set for each channel in accordance with the viewing frequency of the channel. Thus, the higher viewing frequency a channel has, the more frequently the channel will be selected.

In the embodiment described above, the viewing frequency of each channel, i.e., each broadcasting station, is measured. Instead, the viewing frequency may be measured for each program genre, such as drama, music, quiz show, variety, sport or the like. That is, not the viewing frequency of each channel, but the frequency at which the user views any program classified in the program information as drama, music or the like may be recorded. While the user is viewing a certain program, if the channels not displayed include a channel that broadcasts a program of a genre, e.g., drama, which has a high viewing frequency, the non-display-side tuner selects the channel that is broadcasting the drama.

Alternatively, the viewing frequency may be measured for each performer. Further, the user may operate the remote controller 19 or the like, thereby to designate a genre or a performer, and the viewing frequency of the genre or performer thus designated may be measured. Moreover, the broadcasting time may be divided into time brackets, for example, hour brackets as described above, and the viewing frequency of each genre or performer may be measured for each time-bracket.

Still further, if several users use the TV receiver 100 as in a family, the viewing frequency of each user may be measured. In this case, the users are registered in the TV receiver 100 beforehand. Then, any registered user needs only to operate the user-switching button (not shown) on the remote controller 19 if he or she wants to view a TV program. Then, the display unit 17 displays the name of the user, which is viewing the TV program. The remote controller 19 may have a unit that can identify any registered user with, for example, the fingerprint.

When the non-display-side tuner finishes selecting a channel, the program can then be normally received. However, while the non-display-side tuner is still selecting a channel, the program cannot be normally received. The channel number and the program name, in either event, may be displayed by an LED display or by OSD. If OSD is used, channel number and program name are displayed, and superimposed on the image of the program which has been selected by the display-side tuner and which is being displayed by the display unit 17.

[Advantage]

In the second embodiment described above, the non-display-side tuner selects each channel at a time ratio corresponding to the viewing frequency in the past, so that the program broadcast by the channel may be received. Thus, the non-display-side tuner selects a program of a high viewing frequency at high probability. Therefore, the wait time, which elapses until an image is displayed after the program has been switched to another, decreases in most cases. If the viewing frequency is measured for each time bracket or each user, the non-display-side tuner will select a channel in accordance with a more reliable viewing frequency.

During channel surfing, the LED display or OSD informs the user of the channel number, the program name and the completion or incompletion of the channel selection at the non-display-side tuner. This enables the user to operate the remote controller 19 to select another channel before the non-display-side tuner completely selects the channel. Therefore, the user is not stressed when he or she selects a channel. In addition, if the channel selection order of the non-display-side tuner is displayed, the user can know how long he or she should wait until the desired channel is selected. Therefore, the user need not be so anxious about when the desired channel will be selected.

The viewing-frequency histogram will be described in more detail. This histogram has been generated by compiling any one or all of the following data items:

The number of times each channel has been viewed

The number of times each genre (music, sports, drama, quiz, variety) has been viewed

The number of each performer has been viewed

Assume that the user viewed Ch4 50 times and viewed any other channel only 10 times or fewer times in the past in the time bracket from 8:00 to 9:00 on Monday. Then, the probability that the user may view Ch4 on Monday in the 8:00-9:00 time bracket is five or more times higher than the probability that he or she views any other channel on Monday in the same time bracket. Thus, if time five or more times longer is allocated to Ch4 when the non-display-side tuner cyclically selects the other channels while any other channel is being viewed, then the user will quite probably need not wait long to switch the channel. This is because the probability that the user switch the channel is high.

FIG. 11 is a flowchart explaining a process of generating a histogram for each channel. The process is performed under the control of the control unit 14.

When one of the buttons of the remote controller 19 is pushed (if Yes in Block 401), selecting a channel, it is determined which channel has been selected (Blocks 402). Upon lapse of a preset time (Yes in Block 403), the day of the week and the time bracket are determined (Block 405). One (1) is added to the data representing the number of times the channel has been viewed on the day of the week and in the time bracket (Block 406). If the channel selection button of the remote controller 19 is pushed before the preset time elapses (if Yes in Block 404), the flow returns to Block 402.

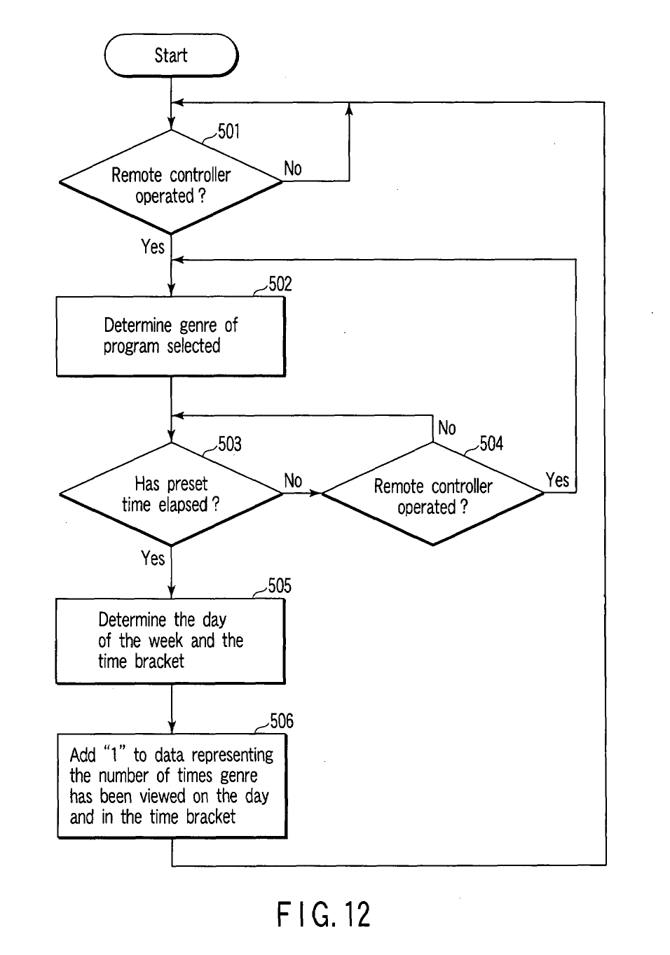

FIG. 12 is a flowchart explaining a process of generating a histogram for each genre. This process is performed under the control of the control unit 14.

When one of the buttons of the remote controller 19 is pushed (if Yes in Block 501), selecting a channel, the genre of the program selected is determined (Block 502). Upon lapse of a preset time (Yes in Block 503), the day of the week and the time bracket are determined (Block 505). One (1) is added to the data representing the number of times the genre has been viewed on the day and in the time bracket (Block 506). If the channel selection button of the remote controller 19 is pushed before the preset time elapses (if Yes in Block 504), the flow returns to Block 502.

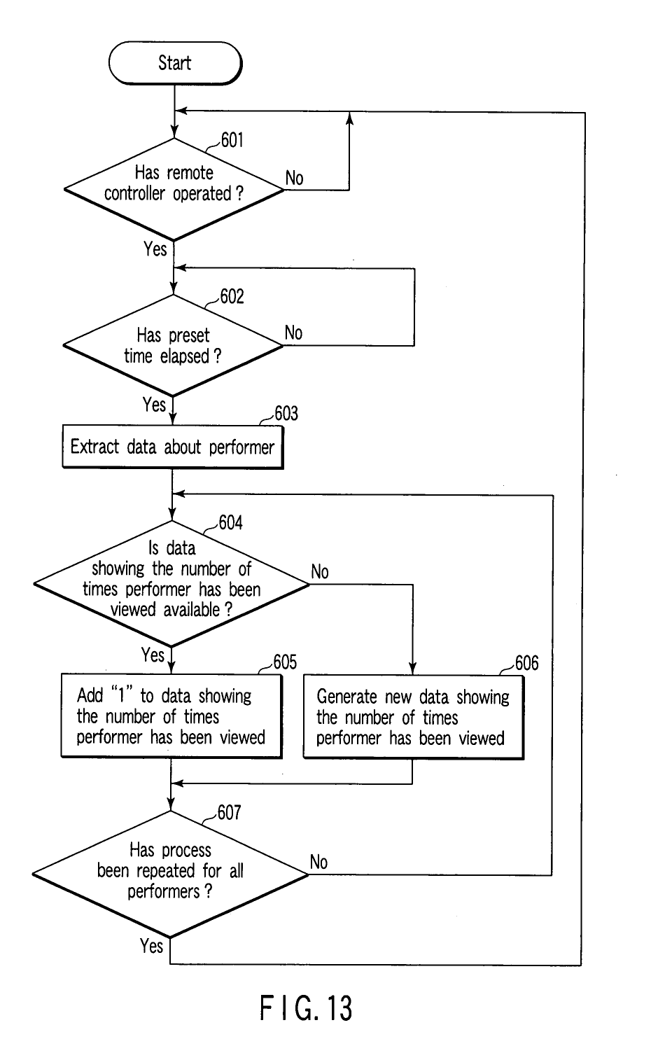

FIG. 13 is a flowchart explaining a process of preparing a histogram for each performer. This process is performed under the control of the control unit 14, too.

When the remote controller 19 is operated, switching the channel to another (Block 601), and upon lapse of a preset time (Yes in Block 602), the data about the performer is extracted from the program information (Block 603). If the data representing the number of times the performer has been viewed is available (if Yes in Block 604), one (1) is added to this data (Block 605). If this data is not available (No in Block 604), data is generated anew (Block 606). This process is repeated for all performers, each time for one performer.

### Third Embodiment

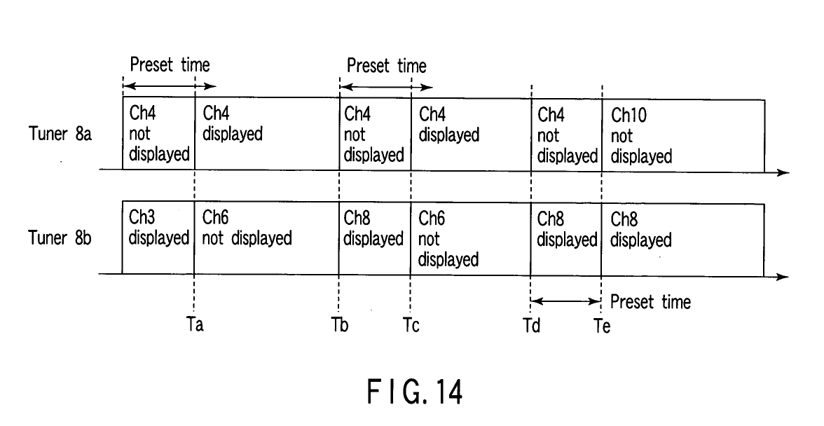

A third embodiment of the present invention will be described. FIG. 14 is a timing chart that illustrates the operation of the third embodiment.

In the third embodiment, if the user switches the program he or she has been viewing longer than a predetermined time to another program, the non-display-side tuner keeps receiving the program. If the user switches the program he or she has not been viewing longer than the predetermined time to another program, the non-display-side tuner starts receiving the other program at once. The third embodiment operates well if the user switches the channel to another when the program starts showing a commercial and if the user switches the channel back to the initially selected channel when he or she thinks the commercial has ended.

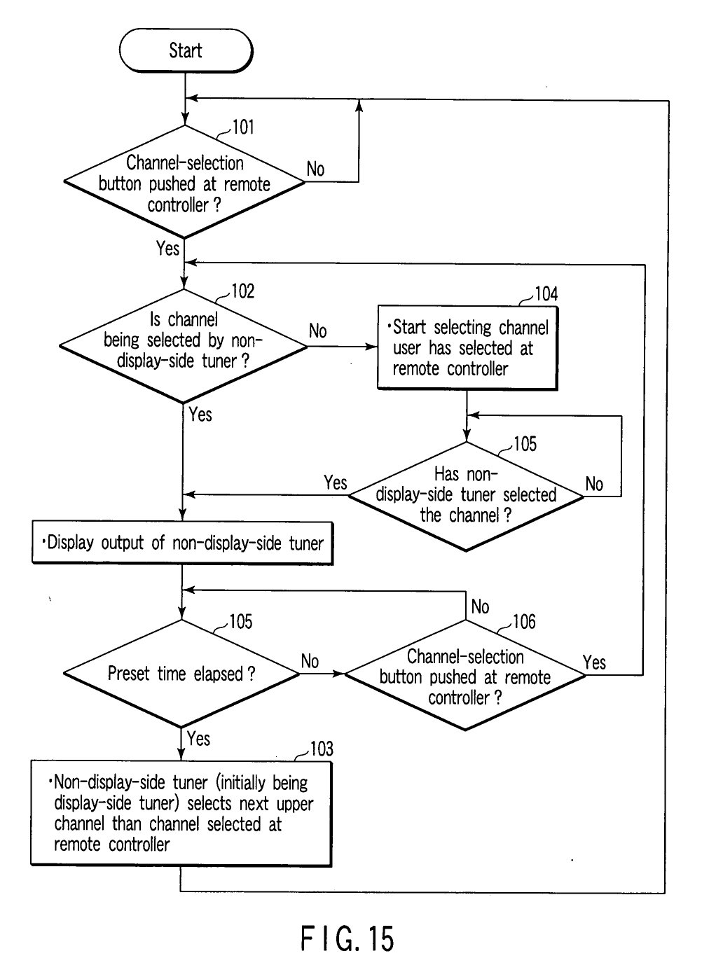

FIG. 15 is a flowchart explaining the operation of the third embodiment. This operation is performed under the control of the control unit 14.

When one of the channel selection buttons of the remote controller 19 is pushed (if Yes in Block 701), selecting a channel, it is determined whether this channel is being selected by the tuner that is the non-display-side tuner at present (Blocks 702). If the channel has been selected by the non-display-side tuner (if Yes in Block 702), the output of the non-display-side tuner is displayed (Block 705). That is, the non-display-side tuner becomes the display-side tuner. Upon lapse of a preset time (Yes in Block 706), the tuner that has just become the non-display-side tuner selects the next upper channel than the channel selected at the remote controller 19.

In Block 702 the channel may not be found to be selected by the non-display-side tuner (No in Block 702). If this is the case, the non-display-side tuner starts selecting the channel the user has selected by pushing a channel selection button of the remote controller 19 (Block 703). When the non-display-side tuner finishes selecting the channel (Yes in Block 704), the output of the non-display-side tuner is displayed. That is, the non-display-side tuner becomes the display-side tuner. Upon lapse of a preset time (Yes in Block 706), the tuner that has just become the non-display-side tuner selects the next upper channel than the channel selected at the remote controller 19 (Block 708).

If the channel selection button of the remote controller 19 is pushed before the preset time elapses (if Yes in Block 707), the flow returns to Block 702. The channel selected at this time is quite probably the channel the non-display-side tuner has selected before it becomes the display-side tuner (that is, before the program starts showing a commercial). The flow therefore goes to Block 705. Thus, the desired channel can be displayed in a short time.

Upon lapse of the preset time, the non-display-side tuner selects the next upper channel than the channel selected at the remote controller 19. Instead, the non-display-side tuner may select the next lower channel than the channel selected at the remote controller 19 or may cyclically select the remaining channels, each at the time ratio corresponding to the viewing frequency in the past. Which one of these channel selection modes should be used may be determined by the type of the remote-control key pushed.

The third embodiment will be described in detail, with reference to FIG. 14.

Assume that the tuner 8b receives Ch3, and the selection unit 21 selects Ch3, Ch3. Also assume that the tuner 8a selects Ch4. At time Ta, the user switches the channel to Ch4. Then, the selection unit 21 is connected to the tuner 8a, and Ch4 now being received is displayed. Since the time Ch3 has been displayed is shorter than the preset time, the tuner 8b immediately starts receiving Ch6, which is an up-side channel to Ch4.

If the user switches the channel to Ch8 at time Tb, the selection unit 21 is connected to the tuner 8b when the tuner 8b becomes able to receive Ch8. Ch8 is thereby displayed. At this time, the tuner 8a keeps receiving Ch4, because Ch4 has been displayed longer than the preset value after time Ta.

When the user switches the channel back to Ch4 at time Tc, the selection unit 21 selects the tuner 8a, whereby Ch4 is immediately displayed. Since Ch8 has been displayed after time Tb for a time shorter than the preset value, the tuner 8b immediately starts receiving Ch6, which is an up-side channel to Ch4.

If the user switches the channel to Ch8 at time Td, the selection unit 21 is connected to the tuner 8b when the tuner 8b becomes able to receive Ch8 in normal way. As a result, Ch8 is displayed. At this time, the tuner 8a keeps receiving Ch4 because Ch4 has been displayed since time Tc for a time longer than the preset time. The user views Ch8 for the preset time. Then, at time Te, the tuner 8a starts receiving Ch10, which is an up-side channel to Ch8.

[Modification]

In the third embodiment, the non-display-side tuner receives a channel that is up-side with respect to the channel the display-side tuner is receiving. Instead, the non-display-side tuner may receive a channel that is down-side with respect to the channel the display-side tuner is receiving. Further, the non-display-side tuner may cyclically receive the remaining channels, each at the time ratio corresponding to the viewing frequency in the past. Still further, the channel being received by the non-display-side tuner may be displayed by an LED display or OSD.

[Advantage]

The user often views a program while the initially selected program is showing commercial, and then switches the program back to the initially selected program when he or she thinks the commercial has ended. In the present embodiment, the non-display-side tuner keeps receiving the initially selected program for a certain time (preset time) after the user has switched the program. Therefore, the program can be switched back to the initially selected one at high speed.

Moreover, if any program that has not been viewed longer than the preset time is switched to another program, the non-display-side tuner immediately selects the next channel. Thus, the high-speed display switching performed in channel surfing to switch one channel to another is never impaired.

### Fourth Embodiment

A fourth embodiment of the present invention will be described. In the fourth embodiment, the non-display-side tuner selects a channel in accordance with the type of the remote-control button the user has pushed.

If the channel-up key 19a is pushed, the non-display-side tuner selects an up-side channel as in the first embodiment (see FIG. 3). Thus, the display switching can be performed at high speed, because the user quite probably pushes the channel-up key 19a again in channel surfing.

If the channel-down key 19b is pushed, the non-display-side tuner selects a down-side channel as in the modification of the first embodiment (see FIG. 5). Therefore, the display switching can be performed at high speed, because the user quite probably pushes the channel-down key 19b again in channel surfing.

If one of the channel selection buttons is pushed, selecting one channel, the other channels are cyclically selected, each at the time ratio corresponding to the viewing frequency in the past, as in the second embodiment (see FIGS. 9 and 10). The probability that the user then pushes the channel selection buttons at random is high. Nonetheless, the longer the time a channel having a high viewing frequency is selected, the higher the probability that the channel selected by the non-display-side tuner is selected. The display switching at the channel switching can therefore be performed at high speed.

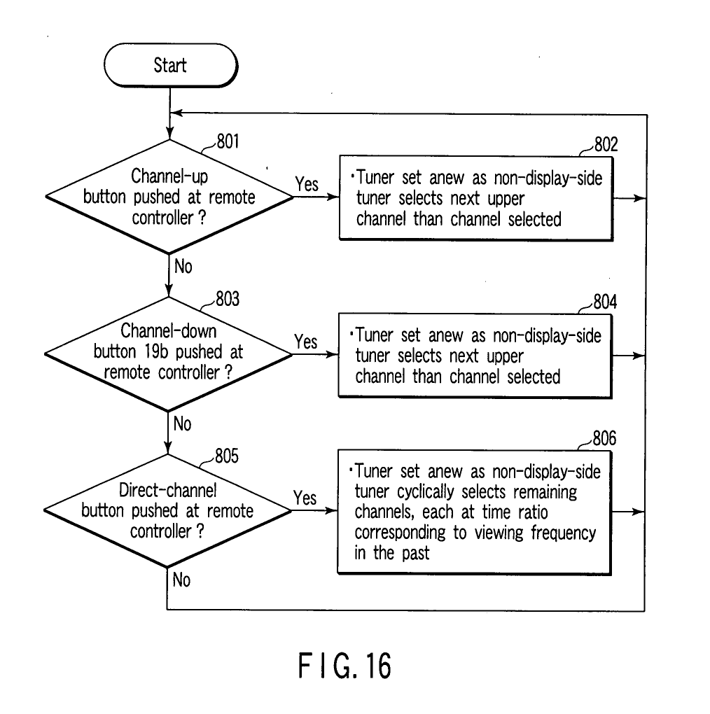

FIG. 16 is a flowchart explaining how the non-display-side tuner selects a channel in the fourth embodiment, in accordance with the type of the channel selection button pushed. This process of selecting a channel is performed under the control of the control unit 14.

If the channel-up button 19a of the remote controller 19 is pushed, selecting a channel (if Yes in Block 801), the tuner set anew as non-display-side tuner selects the next upper channel than the channel selected (Block 802). If the channel-down button 19b of the remote controller 19 is pushed, selecting a channel (if Yes in Block 803), the tuner set anew as non-display-side tuner selects the next lower channel than the channel selected (Block 804). If one button of the direct-channel button pad 19c, the tuner set anew as non-display-side tuner cyclically selects the remaining channels, each at the time ratio corresponding to the viewing frequency in the past (Block 806).

[Advantage]

In the present embodiment, the non-display-side tuner selects a channel in accordance with the type of the channel selection button pushed. Therefore, the non-display-side tuner selects, at high probability, the channel the user wants to select. Thus, the display switching at the channel switching can be performed at high speed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A digital broadcast channel selection apparatus comprising:
first and second tuners each receive digital broadcast signals, select a channel and provide program data containing video data and audio data of the channel selected;
a selection unit which selects one of the first and second tuners and provides program data acquired from the tuner selected; and
a control unit which causes the selection unit to select one of the first and second tuners in accordance with a channel selection instruction and which controls the other tuner so as to select a channel adjacent to the channel selected by the one of the tuners.

2. The apparatus according to claim 1, wherein when the selection unit selects one of the first and second tuners, the control unit controls the other tuner so as to select a channel that is an up-side channel to the channel selected by the one of the first and second tuners.

3. The apparatus according to claim 1, wherein when the selection unit selects one of the first and second tuners, the control unit controls the other tuner so as to select a channel that is a down-side channel to the channel selected by the one of the first and second tuners.

4. The apparatus according to claim 1, further comprising a histogram-generating unit which generates a viewing-frequency histogram by recording a viewing frequency of a program viewed on the channel selected by one of the first and second tuners, which in turn has been selected by the selection unit,
wherein the control unit controls the other tuner while the selection unit is selecting the one of the tuners, so as to cyclically select any channel other than the channel selected by the one of the first and second tuners, in accordance with the viewing-frequency histogram generated by the histogram-generating unit.

5. The apparatus according to claim 4, further comprising a setting unit configured to perform one of setting processes first of which is to cause the other tuner to select an up-side channel to the channel selected by the one of the first and second tuners, second of which is to cause the other tuner to select a down-side channel to the channel selected by the one of the first and second tuners, and third of which is to cause the other tuner to cyclically select a channel other than the channel selected by the one of the first and second tuners in accordance with viewing-frequency histogram generated by the histogram-generating unit.

6. The apparatus according to claim 4, wherein the histogram-generating unit records a channel number of the program viewed, thereby to generate a viewing-frequency histogram for the channel.

7. The apparatus according to claim 4, wherein the histogram-generating unit records the genre of the program viewed, thereby to generate a viewing-frequency histogram for the genre.

8. The apparatus according to claim 4, wherein the histogram-generating unit records the performer of the program viewed, thereby to generate a viewing-frequency histogram for the performer.

9. A digital broadcast channel selection apparatus comprising:
a channel selection unit which receives a digital broadcast signal and selects a specific channel, thereby providing a program data containing the video data and audio data of the channel selected;
an expanding unit which expands the program data provided by the channel selection unit; and
a display unit which displays an image represented by the program data expanded by the expanding unit,
the channel selection unit comprising:
first and second tuners each receive digital broadcast signals, select a channel provide program data containing video data and audio data of the channel selected;
a selection unit which selects one of the first and second tuners and provides program data acquired from the tuner selected; and
a control unit which causes the selection unit to select one of the first and second tuners in accordance with a channel selection instruction and which controls the other tuner so as to select a channel adjacent to the channel selected by the one of the tuners.

10. The apparatus according to claim 9, wherein the control unit displays a message informing that a channel is being selected until the non-display tuner finishes channel selection after the control unit has given the non-display-side tuner a channel selection instruction, in an image of a program selected by a display-side tuner and displayed on the display unit, the display-side tuner being one of the first and second tuners which is selecting a channel of the program being displayed on the display unit, and the non-display-side tuner being the other tuner which is selecting a channel other than the channel of the program being displayed on the display unit.

11. The apparatus according to claim 9, wherein when the program is switched from an initially selected program displayed on the display unit for a time more than a constant time to another program, the control unit causes a non-display-side tuner to keep selecting the initially selected program for a predetermined time after the program is switched, the non-display-side tuner being one of the first and second tuners, which is selecting a channel other than the channel of the program being displayed on the display unit.

12. A digital broadcast channel selection method comprising:
receiving digital broadcast signals by using first and second tuners, selecting channels from the digital broadcast signals, respectively, and providing program data containing the video data and audio data of the channels selected; and
selecting one of the first and second tuners in accordance with a channel selection instruction input, providing the program data acquired from the tuner selected, and controlling the other tuner so as to select a channel adjacent to the channel selected by the one of the first and second tuners.
